(19) United States
(12) Patent Application Publication
(10) Pub. No.: US 2014/0037841 A1
(43) Pub. Date: Feb. 6, 2014

(54) ANTIREFLECTIVE COATINGS WITH CONTROLLABLE POROSITY AND DURABILITY PROPERTIES USING CONTROLLED EXPOSURE TO ALKALINE VAPOR

(71) Applicants: Scott A. Jewhurst, Redwood City, CA (US); Nikhil Kalyankar, Hayward, CA (US)

(72) Inventors: Scott A. Jewhurst, Redwood City, CA (US); Nikhil Kalyankar, Hayward, CA (US)

(73) Assignee: Intermolecular, Inc., San Jose, CA (US)

(21) Appl. No.: 13/565,999

(22) Filed: Aug. 3, 2012

(51) Int. Cl. B05D 5/06; B05D 3/02; B05D 3/04

(52) U.S. Cl. 427/164

(57) ABSTRACT

In some embodiments, the present invention discloses methods and apparatuses for making coated articles comprising exposing the coated layer to vapor-phase agents to modify its properties, such as the bonding and distribution of the coating mass. The coated layer is a porous solid layer, deposited via methods such as sol-gel, physical or chemical vapor deposition, aerosol deposition, or other methods capable of depositing a porous solid coating, with or without further processing such as curing or heat treatment.

### FIELD OF THE INVENTION

Embodiments of the invention relate generally to methods and apparatuses for forming antireflection layers on substrates.

### BACKGROUND OF THE INVENTION

Coatings that provide low reflectivity or a high percent transmission over a broad wavelength range of light are desirable in many applications including semiconductor device manufacturing, solar cell manufacturing, glass manufacturing, and energy cell manufacturing. The refractive index of a material is a measure of the speed of light in the material which is generally expressed as a ratio of the speed of light in vacuum relative to that in the material. Low reflectivity coatings generally have a refractive index (n) in between air (n=1) and glass (n˜1.5).

An antireflective (AR) coating is a type of low reflectivity coating applied to the surface of a transparent article to reduce reflectivity of visible light from the article and enhance the transmission of such light into or through the article thus decreasing the refractive index. One method for decreasing the refractive index and enhancing the transmission of light through an AR coating is to increase the porosity of the antireflective coating. Porosity is a measure of the void spaces in a material. Although such antireflective coatings have been generally effective in providing reduced reflectivity over the visible spectrum, the coatings have suffered from deficiencies when used in certain applications. For example, porous AR coatings which are used in solar applications are highly susceptible to moisture absorption. Moisture absorption may lead to an increase in the refractive index of the AR coating and corresponding reduction in light transmission.

Thus, there is a need for AR coatings which exhibit increased transmission, reliability and durability.

### SUMMARY OF THE DISCLOSURE

In some embodiments, the present invention discloses methods and apparatuses for making coated articles comprising exposing the coated layer to vapor-phase agents which act as a mineralizer and as a sol-gel catalyst to modify its properties, such as the bonding and distribution of the coating mass, through the chemical effects of the mineralizer vapors. The coated layer is a porous solid layer, deposited via methods such as sol-gel, physical or chemical vapor deposition, aerosol deposition, or other methods capable of depositing a porous solid coating, with or without further processing such as curing or heat treatment. In some embodiments, the present invention discloses modifications of the surface chemistry and porosity network structure of an already formed (and partially or fully cured) porous silica coating through the chemical effects of ammonia and water or primary alcohol vapors. The process may also use other basic (i.e. alkaline) vapors. The present process can have effects on coatings that have not been subjected to high temperatures (e.g., temperatures above 300 C), or on porous silica gels that have been subjected to temperatures sufficient to dehydroxylate (silanol elimination) silica surfaces (e.g., >3000).

In some embodiments, the coated layer is deposited using a sol-gel process. For example, a gel using various particle containing sol formulations and/or various binders could be coated on a substrate to form the coated layer. For example, a silica sol, where silica sol is a solution comprising silicon, can be used as a precursor to deposit the coated layer. As examples, alkylalkoxysilane or bis(alkoxyalkylsilane) based sol-gel formulations can be coated on a glass substrate to form anti-reflective coatings with controlled porosity and durability. After coating, curing and heat treatment can be performed to evaporate solvent and solidify the sol-gel coatings.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIGS. 1A-1C illustrate an exemplary porous coating according to some embodiments of the present invention.

FIGS. 2A-2E illustrate a schematic of mass redistribution according to some embodiments of the present invention.

FIGS. 3A-3B illustrate schematics of exemplary mass redistribution according to some embodiments of the present invention.

FIGS. 4A-4B illustrate a schematic process for mass distribution according to some embodiments of the present invention.

FIG. 5A-5B illustrate a potential effect of ammonia on silica particles according to some embodiments of the present invention.

FIG. 6A-6B illustrate another potential effect of ammonia on silica particles according to some embodiments of the present invention.

FIGS. 7A-7C illustrate exemplary flowcharts to process a porous coating according to some embodiments of the present invention.

FIGS. 8A-8B illustrate other exemplary flowcharts to process a porous coating according to some embodiments of the present invention.

FIGS. 9A-9B illustrate other exemplary flowcharts to process a porous coating according to some embodiments of the present invention.

### DETAILED DESCRIPTION OF THE PREFERRED EMBODIMENTS

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

In some embodiments, the present invention discloses methods, and coated articles fabricated from the methods, comprising exposing a coated layer to vapor-phase agents which act as a mineralizer and/or as a sol-gel catalyst to modify its properties, such as the bonding and distribution of the coating mass, through the chemical effects of the mineralizer vapors. For example, a very thin layer of mineralizer (ammonia, etc.) and solvent (water, alcohol, etc.) is condensed on the surfaces of the solid phase, facilitating the mass transport or redistribution of the coated layer. The coated layer can be a porous solid layer, deposited via methods such as sol-gel, physical or chemical vapor deposition, aerosol deposition, or other methods capable of depositing a porous solid coating, with or without further processing such as curing or heat treatment.

In some embodiments, the present invention discloses modifications of the surface chemistry and porosity network structure of a porous coating through the chemical effects of ammonia and water or primary alcohol vapors. Other alkaline vapors can also be used.

In some embodiments, the porous coating includes a coating that has pores, e.g., cavities or channels, already formed within the coating. The pores can be open pores, e.g., pores which have a channel of communication with the external surface, or closed pores, e.g., pores that are totally isolated from their neighbors. The porous coating can be a solid coating, e.g., not a liquid coating or a gel-like coating that can change shape and size. The porous coating can be a dry coating, e.g., the porous coating can have minimum (e.g., a negligible amount) or no liquid in liquid phase. For example, the porous coating can have some liquid in vapor phase, such as moisture. There can be no liquid in liquid phase, e.g., the pores are not completely or partially filled with liquid.

In some embodiments, the porous layer can be formed by a thermal treatment of a sol-gel coating, e.g., evaporating or combusting the solvent to create pores in a binder network. In a sol-gel process, a solution (called sol) can gradually evolve toward the formation of a gel-like coating containing both a liquid phase (a solvent) and a solid phase (such as discrete particles or a continuous polymer network). A thermal treatment (such as a drying process) of the gel-like coating can remove the liquid, forming a porous coating having pores distributed throughout the coating.

In some embodiments, the porous coating, for example, a coating formed from a sol-gel process, can be further heat treated (such as a firing or curing process), for example, to remove moisture and enhance structural stability of the porous coating. The curing process can be partially (e.g., the coating can be further processed with longer time or higher temperature heat treatment) or fully performed (e.g., the coating achieves complete moisture removal or structural completion).

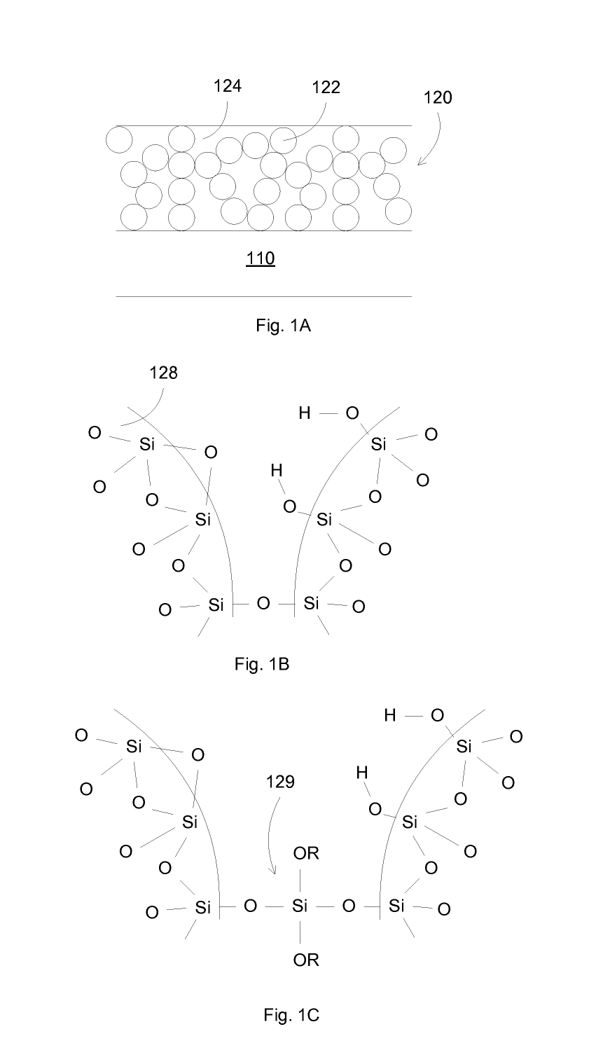

FIGS. 1A-1C illustrate an exemplary porous coating according to some embodiments of the present invention. In FIG. 1A, a porous layer 120 is disposed on a substrate 110. The porous layer 120 can comprise particles 122 disposed in a network 124. The particles are shown as spherical particles, but can be any shapes and sizes, such as elliptical particles or disk-shaped particles. The network can comprise a binder to connect the particles 122.

FIG. 1B shows exemplary silica-based particles, e.g., SiO₂, 128, bonded through shared oxygen atoms. The surface of the silica particles can comprise silanol (—Si—OH) or siloxane (—Si—O—Si—). FIG. 1C shows the same silica-based particles 128, bonded through a binder 129. The binder 129 can be an organosilicate monomer (e.g., R′ₙ—SiOR)₄₋ₙ, n=0-2), oligomeric organosilicate, or a bis-silane (e.g. (R′ₙ(OR)₃₋ₙSi)₂R″, n=0-1).

In some embodiments, the present invention discloses methods, and coated articles formed by the methods, comprising chemically treating a coated porous layer in an active ambient. For example, the chemical treatment of the coated layer can be performed in a controlled atmosphere containing a curing and mineralizing agent such as ammonia. The base ambient comprises an alkaline vapor and preferably also comprises a hydroxyl-containing vapor, such as water or alcohol. In some embodiments, the alkaline vapor comprises vapor of a basic material, e.g., a compound that can accept a proton (such as a hydrogen ion H⁺). For example, the base material can be ammonia or other alkaline vapors (amines, hydroxylamines, quarternary ammonium hydroxides).

In some embodiments, the chemical treatment in an alkaline ambient can be performed at any temperature, and preferably at room temperature. The treatment can be performed in less than or equal to about 1000 minutes, and preferably less than or equal to about 100 minutes. Higher temperatures can be used, preferably in a closed environment to retain the vapor, for example, at less than or equal to about 200 C.

In some embodiments, the coated layer, after being chemically treated with an alkaline vapor, is further subjected to an optional heat treatment, for example, to dry the coating or to sinter the coated layer. In some embodiments, after exposing the coated layer to an alkaline vapor for some duration, the substrate is removed from the alkaline vapor ambient. Evaporation of the absorbed alkaline vapor on the coated layer can be preformed, either at room temperature or at an elevated temperature (e.g., at less than about 300 C). An optional heat treatment of the modified coated layer can be performed to dehydrate the layer or to allow viscous sintering.

In some embodiments, the chemical treatment in an alkaline vapor can generate a reaction in the coated layer, for example, to increase coating adhesive and cohesive strength, as well as allowing modification of the refractive index and spectral response of the coatings through film porosity modification, which can enhance mechanical and optical property.

In some embodiments, the present invention discloses a chemical treatment of a solid and porous silica layer to allow limited dissolution of silica which will precipitate at areas of negative curvature and lower pH (contact points between particles, regions of the film farther from the film surface in contact with the ammonia and water vapors).

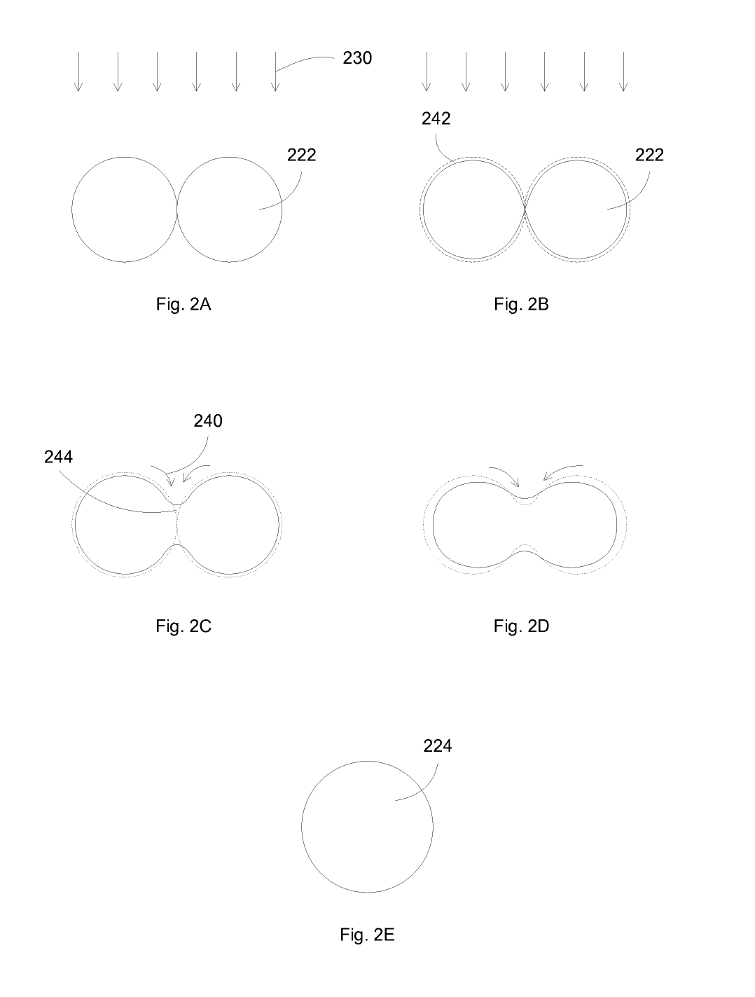

FIGS. 2A-2E illustrate a schematic of mass redistribution according to some embodiments of the present invention. In FIG. 2A, particles 222 are exposed to an active environment 230, which can absorb on the particle surface. As shown, the active environment 230 is shown as directing in one direction, but in general, the active environment can be have preferred directions or can be isotropic, e.g., similarly affecting the particles in all directions.

In FIG. 2B, a portion 242 of the particles can be dissolved under the influence of the active environment. In some embodiments, the active environment can comprise an ambient that can increase the solubility of the particles. For example, a dissolving layer of material can exist at the external surfaces of the particles. An active environment can comprise ammonia NH₃, together with OH groups, for example, from water vapor. Under the surface-absorbed ammonia/water vapor, the solubility of silicon increases greatly, and a portion 242 comprising silicon can be dissolved at the particle surface.

In FIG. 2C, the dissolved portion of the particles can travel 240 to regions of lower energy. For example, the dissolved portion can migrate from regions of positive curvature to regions of negative curvature. For example, silica can be dissolved from the skin layer 242, which reacts with water molecules to form silicic acid Si(OH)₄.

2H₂O+SiO₂=Si(OH)₄

The dissolved portion can settle at the contact point 244 between two particles, strengthening the bonding between the particles. For example, the silicic acid Si(OH)₄ can be bonded with the neighbor silica-based particles. When the absorbed ammonia and/or water vapor is removed, the particles solidify with improved bonding strength. The removal of ammonia or water vapor can be performed by evacuating the vapors, or by transferring the substrate to a clean environment. Alternatively, an optional heat treatment can be performed.

In FIGS. 2D and 2E, the process can continue until reaching equilibrium, for example, when the two particles 222 merge to form a larger particle 224.

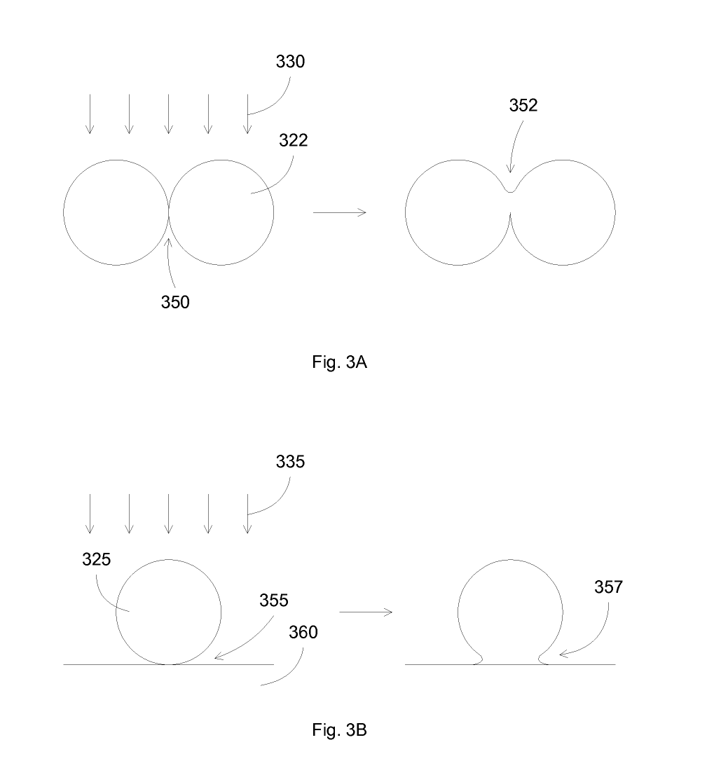

FIGS. 3A-3B illustrate schematics of exemplary mass redistribution according to some embodiments of the present invention. In FIG. 3A, the particles 322 are exposed to an active environment 330, such as a vapor environment that can increase the solubility of the particles. A portion of the particles is dissolved, for example, under the influence of the absorbed active vapor. The dissolved portion is then redistributed to regions of lower energy, such as the contact points 350 between the particles. After re-solidified, for example, by evaporating the absorbed active vapor through a heat treatment, the bonding between the particles is strengthen by the addition of mass 352, redistributed from the dissolved portions. The active vapor can comprise ammonia molecules and OH groups, to generate an ambient of high pH (e.g., >11), which can facilitate the solubility of silica.

In FIG. 3B, a particle 325 is exposed to an active environment 335, such as a vapor environment that can increase the solubility of the particles. A portion of the particles is dissolved, for example, under the influence of the absorbed active vapor. The dissolved portion is then redistributed to regions of lower energy, such as the contact points 355 of the particle 355 with the substrate 360. After re-solidified, for example, by evaporating the absorbed active vapor through a heat treatment, the bonding between the particle and the substrate is strengthened by the addition of mass 357, redistributed from the dissolved portions. The active vapor can comprise ammonia and OH molecules, to generate an ambient of medium pH (e.g., >8), since the substrate, e.g., a glass substrate, can comprise sodium, which can act as a mineralizer to facilitate the solubility of silica.

In some embodiments, the present treatment alters the mechanical properties or porosity distribution within a porous silica film once it has been formed. For example, the chemical treatment can allow modification of pore distribution to create advantageous gradient and enhanced anti-reflection properties. In some embodiments, the chemical treatment process can allow creation of advantageous porosity gradient from previously uniform porosity distribution. For example, the redistribution of mass in the porous coating can result in an increase in the pore volume fraction at the coating-air interface while decreasing the pore volume fraction at the coating-substrate interface, which results in a porosity and refractive index gradient that would result in an improvement of anti-reflection properties. In some embodiments, the mass redistribution through the present chemical treatment can be applied to fully cured (chemically or thermally at temperatures higher than 300 C) anti-reflective coatings.

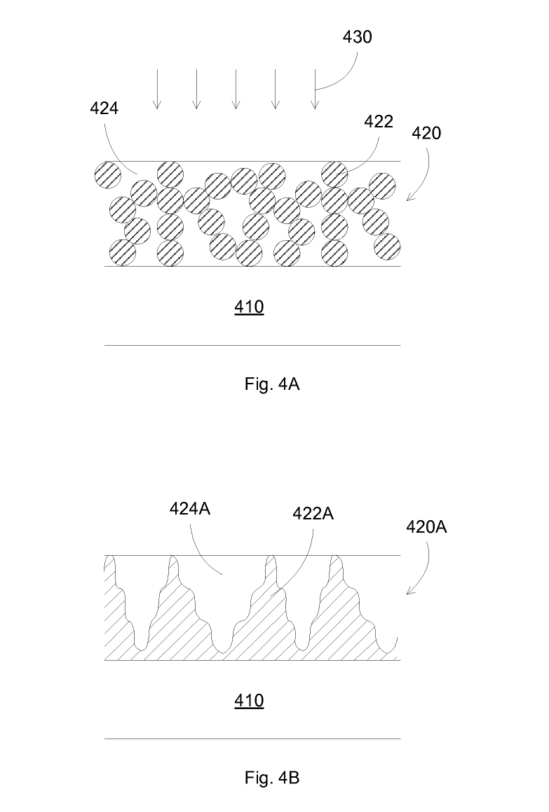

FIGS. 4A-4B illustrate a schematic process for mass distribution according to some embodiments of the present invention. In FIG. 4A, a porous layer 420, comprising particles 422 disposed in a network 424, is coated on a substrate 410. As coated, the porous layer 420 can be uniform in porosity, e.g., the particles and the pores can be distributed uniformly within the layer 420. The term “uniformly distributed” is viewed in a macroscopic sense, meaning at the dimension of the particles, there might be some denser or coarser regions. But on the average, meaning at regions having dimension of hundred or thousand times the particle size, the distribution of particles and porosity is uniform.

The porous layer 420 is exposed to an active vapor, which can facilitate the dissolving of the particles through the absorbed vapors. For example, silica particles have very low solubility in water, but can be soluble in the adsorbed (or condensed) layer of a mixture of water and amine (such as ammonia), a mixture of alcohol and amine (such as ammonia) or a pure amine (aminoalcohols, propylamine, etc). Exposing silica particles to an alkaline vapor, such as ammonia, can increase the solubility of the particles, dissolving a portion of the particles. The dissolved portion of the particles will migrate to regions of lower energy, for example, regions of negative curvature which comprise the contact points between particles, or the contact points of the particles and the substrate.

FIG. 4B shows an exemplary configuration of the redistribution of the mass of the particles after some exposure time. A majority of the particle mass is settled near the substrate, forming pyramid-like structures 422A in network 424A. The resulting layer 420A, after the active vapor exposure, comprises a gradient of porosity, with denser region near the substrate.

In some embodiments, the dissolution-precipitation of the particle mass, e.g., a portion of the particles is dissolved from a region and then precipitated at another region, occurs in OH ambient, such as water or alcohol vapor. For partially cured coated layer, moisture can be present in the pores of the porous layer, thus the reaction can be performed without or with minimum addition of OH molecules. For fully cured coated layer, meaning the layer has been heat treated to remove all moisture, additional OH molecules can be added to the active environment. Thus the present mass redistribution can be performed for partially cured porous layer, e.g., a gel coating with partially heat treatment for forming porous structure. The present mass redistribution can also be performed for fully cured porous layer.

In some embodiments, the present chemical treatment can improve the mechanical durability of porous sol-gel silica coating, together with optimizing of coating refractive index and thickness by porosity alteration and/or gradation. The improvement of durability can occur through enhancement of curing and aging of porous silica coatings, increasing the ratio of siloxane to silanol groups (condensation curing), for example, in coating and between coating and substrate (pH>8) on coatings that have not been subjected to high temperatures (>3000). The present process can also have effects on porous silica gels that have been subjected to temperatures sufficient to dehydroxylate (silanol elimination) silica surfaces (e.g., >3000). Further, durability improvement can also occur through redistribution of coating mass from regions of positive curvature to negative curvature by a dissolution-precipitation mechanism.

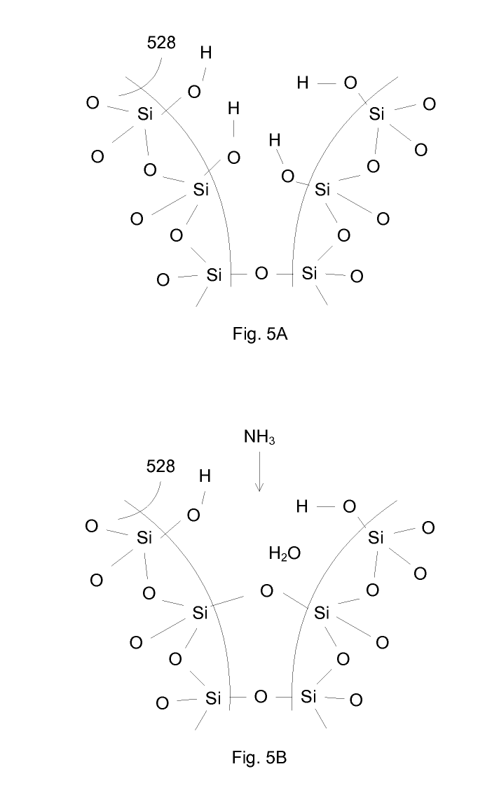

FIG. 5A-5B illustrate a potential effect of ammonia on silica particles according to some embodiments of the present invention. In FIG. 5A, adjacent silica-based particles 528, e.g., particles comprising SiO2, are bonded through oxygen atoms for surface silicon atoms. Other surface silicon can accept absorbed water, and can be bonded to OH molecules. In FIG. 5B, the silica-based particles are exposed to ammonia vapor, in addition to OH-containing components, such as water or alcohol. Condensation bonding can occur between nearby —Si—OH groups, forming —Si—O—Si— bonding, and releasing H₂O. The condensation bonding can strengthen the linkage between particles through the additional bonding of surface silicon.

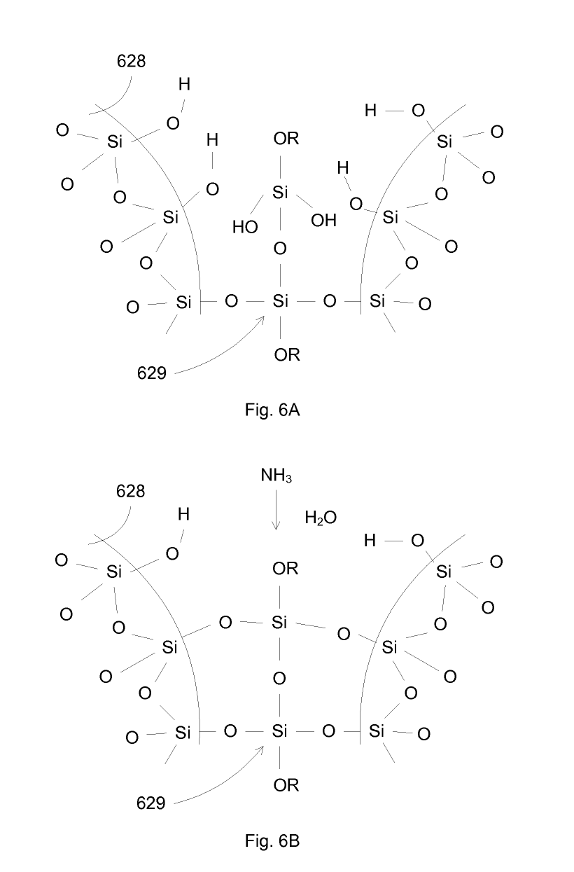

FIG. 6A-6B illustrate another potential effect of ammonia on silica particles according to some embodiments of the present invention. In FIG. 6A, adjacent silica-based particles 628, e.g., particles comprising SiO₂, are bonded through partially hydrolyzed silicon alkoxide or alkoxysilane binder 629. Other surface silicon can accept absorbed water, and can be bonded to OH molecules. In FIG. 6B, the silica-based particles are exposed to ammonia vapor, in addition to OH-containing components, such as water or alcohol. Condensation bonding can occur between —Si—OH groups and the —Si—OH in the binder, forming —Si—O—Si-bonding, and releasing H₂O. The condensation bonding can strengthen the linkage between particles through the additional bonding of surface silicon.

In some embodiments, the present chemical treatment can provide improvement in mechanical durability, refractive index modification, and spectral response of existing anti-reflection coating formulations without requiring high-temperature processing. The enhancement of mechanical durability and optical property modification may be applied before or after heat-treatment of the porous layer, providing flexibility towards integration into existing manufacturing processes.

In some embodiments, the present invention discloses methods, and coated articles formed by the methods, comprising exposing an already-formed and dried coated layer to an alkaline ambient. The coated layer is preferably a solid layer, for example, in gel form or hardened form. In some embodiments, the coated layer can be dried or annealed before exposing to the alkaline ambient. For example, the coated layer can be thermally cured for forming silica network or for strengthening the bonding formation within the coated layer. The coated layer can also be calcinated at high temperatures to form a solid porous silica layer. For example, the coated layer is subjected to high temperature drying or curing at or below about 300 C, or to high temperature calcination at or above about 300 C.

In some embodiments, the coated layer comprises a solid porous silica layer, which can be deposited using a liquid precursor and then dried or cured. The precursor can be comprised of small particles in a solvent mixture, for example, comprising nano sized particles, silica-based particles or silica-based nanoparticles. The precursor can be prepared using a polymeric silica sol in a solvent. The silica polymer can comprise an organosilicate monomer (e.g., R′ₙ—Si—(OR)₄₋ₙ, n=0-2), oligomeric organosilicate, or a bis-silane (e.g. (R′ₙ(OR)₃₋ₙSi)₂R″, n=0-1). The precursor can also be prepared as a mixture of silica particles and organosilicate in a solvent. The deposition process can be performed by spin coating, dip coating, curtain coating, or any other liquid coating process.

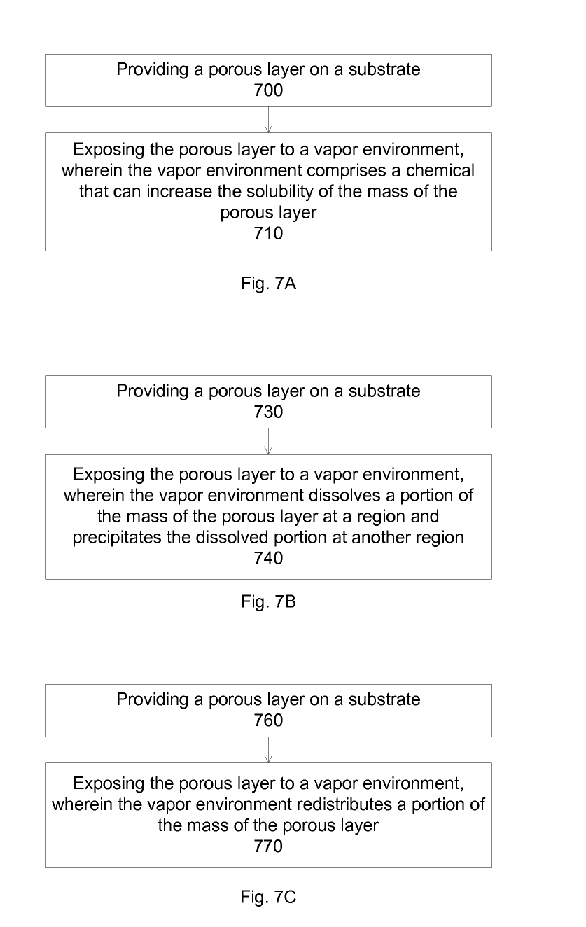

FIGS. 7A-7C illustrate exemplary flowcharts to process a porous coating according to some embodiments of the present invention. FIG. 7A discloses a vapor environment comprising a chemical that can increase the solubility of the mass of the porous coating as compared to the solubility in air. The increase in solubility is preferably adequate to dissolve the mass of the porous layer at regions where the chemical vapor absorbed thereon.

In operation 700, a porous layer is provided on a substrate. The substrate is preferably a transparent substrate, such as a glass substrate or a polymer substrate. The porous layer comprises a material mass distributed as to include empty spaces, e.g., pores, throughout the porous layer. The porous layer can comprise closed pore structures, meaning the pores are distributed in a network without being connected to each other. The porous layer can comprise open pore structures, meaning the pores are distributed in a network and connected to each other. The porous layer can comprise a combination of closed pore structures and open pore structures. The porous layer can comprise a plurality of pores distributed in the layer. The porous layer can comprise a plurality of particles distributed in the layer, wherein the space between the particles forms the pore structure.

In operation 710, the porous layer is exposed to a vapor environment, which comprises a chemical that can increase the solubility of the mass of the porous layer. The vapor can be absorbed on the porous layer, not only on the outer surface but also within the porous layer, due to the porous nature of the porous layer. At the absorbed sites, the solubility of the layer mass increases, and the layer mass can be dissolved, which then can migrate to regions with lower energy. The chemical and/or the concentration of chemical in the vapor environment are preferably selected so that the layer mass can be locally dissolved when absorbed on the surface.

FIG. 7B discloses a vapor environment comprising a chemical that can exhibit a dissolution-precipitation mechanism on portions of the mass of the porous coating. A portion of the coating mass can be dissolved at a region having high energy, such as regions of positive curvature, and then migrating to and precipitating at regions of low energy, such as regions of negative curvature.

In operation 730, a porous layer is provided on a substrate. In operation 740, the porous layer is exposed to a vapor environment that is capable of dissolving a portion of the mass of the porous layer at a first region and then precipitating the dissolved portion at a second region. For example, the environment can comprise a solvent for the material of the porous layer. The solvent vapor, when absorbed on the porous layer, can dissolve the mass of the porous layer. The dissolved portion can precipitate, for example, when the solvent vapor is removed, for example, by evacuating the solvent vapor or by heating the porous layer. For inhomogeneous porous layer, the solvent can be selected to selectively affect different materials of the porous layer. For example, in a porous layer comprising silica particles disposed in a binder network, the solvent can comprise an alkaline element, which can dissolve silica in the presence of water.

FIG. 7C discloses a vapor environment comprising a chemical that can redistribute portions of the mass of the porous coating. The redistribution of mass can affect the distribution of the pore structures, potentially enhancing the antireflective property of the porous layer.

In operation 760, a porous layer is provided on a substrate. In operation 770, the porous layer is exposed to a vapor environment, wherein the mass of the porous layer can be redistributed under the influence of the absorbed vapor. The redistribution can occur through a dissolution-precipitation mechanism as discussed above.

In some embodiments, the present invention discloses methods for forming a porous layer having improved antireflective property. The methods comprise exposing a porous layer comprising silica-based particles to an alkaline vapor environment, such as ammonia vapor. In some embodiments, the alkaline vapor environment can include alkaline species that condense to a liquid on the particles/coating and can act as a solvent. In some embodiments, the alkaline vapor environment can include ammonia vapor (e.g., alkaline vapor) and OH groups. The OH groups can be present in the vapor. Or the OH groups can be present in adsorbed moisture or alcohol which can already be on the particles/coating.

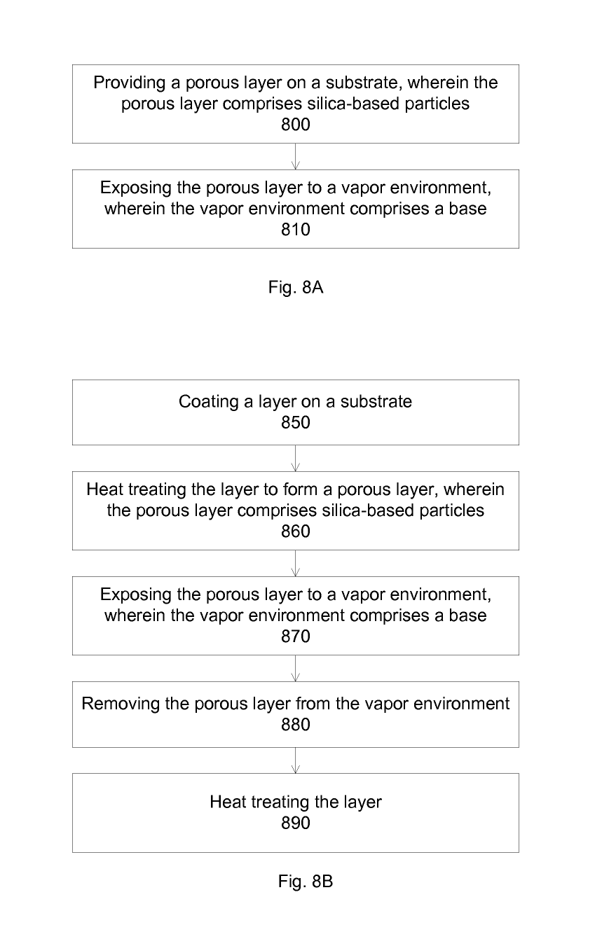

FIGS. 8A-8B illustrate other exemplary flowcharts to process a porous coating according to some embodiments of the present invention. FIG. 8A discloses a method to improve an antireflection property of a porous layer comprising silica-based particles by exposing the porous layer to an ambient comprising an alkaline vapor, such as ammonia. In operation 800, a porous layer is provided on a substrate, wherein the porous layer comprises silica-based particles. For example, the porous layer can be formed by a sol-gel process, coating the substrate with a sol formulation comprising a binder and silica-based particles. The coating of sol formulation can be dried and partially cured to form a porous layer. Alternatively, the coating of sol formulation can be fully cured to form a porous layer with different property, such as cross link of the binder network or removing moisture absorption.

In operation 810, the porous layer is exposed to a vapor environment, wherein the vapor environment comprises an alkaline vapor, such as ammonia. The alkaline vapor can increase the solubility of silica, for example, with water and/or sodium catalyst. The silica-based particles can be dissolved at regions where the alkaline vapor is absorbed. The mass of the silica-based particles can be redistributed under the influence of the absorbed alkaline vapor. The redistribution of mass can form a gradient of pore density, improving the antireflective property. In addition, the alkaline ambient can enhance the durability and strength of the porous layer.

FIG. 8B discloses another method to improve an antireflection property of a porous layer comprising silica-based particles by exposing the porous layer to an ambient comprising an alkaline vapor, such as ammonia. In operation 850, a layer is coated on a substrate. For example, the coated layer can comprise a sol formulation comprising a binder and silica-based particles. In operation 860, the coated layer is heat treated, to be partially or fully cured to form a porous layer. In operation 870, the already-formed porous layer is exposed to an alkaline vapor, which can improve the antireflective property, and the durability property of the porous layer. In operation 880, the porous layer is removed from the alkaline vapor, for example, by evacuating the alkaline vapor or by transferring the substrate to another ambient. In operation 890, the porous layer, or the substrate, is heat treated, for example, to remove absorbed alkaline vapor on the porous layer.

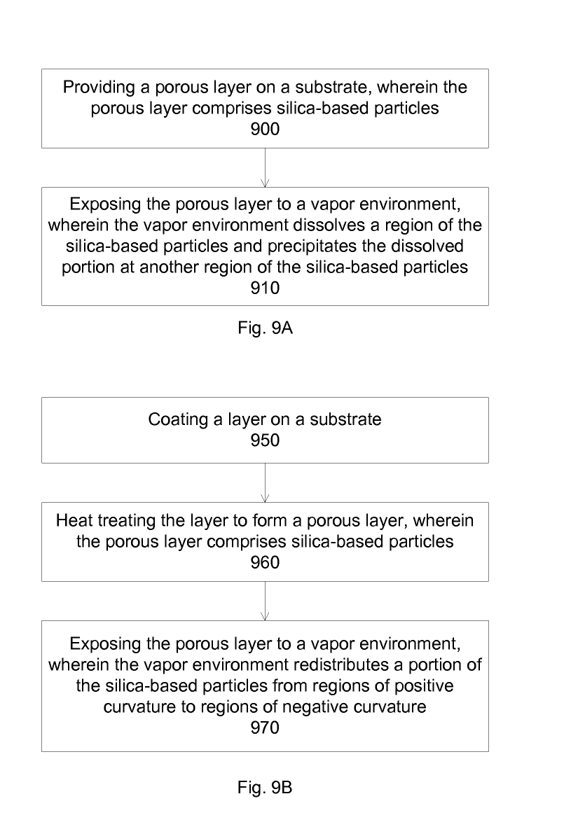

FIGS. 9A-9B illustrate other exemplary flowcharts to process a porous coating according to some embodiments of the present invention. FIG. 9A discloses a method to improve an antireflection property of a porous layer comprising silica-based particles by exposing the porous layer to an ambient wherein the vapor in the ambient can increase the solubility of silica, thus can facilitate dissolution of the silica-based particles. In operation 900, a porous layer is provided on a substrate, wherein the porous layer comprises silica-based particles. In operation 910, the porous layer is exposed to a vapor environment that is capable of dissolving a portion of the silica-based particles at a first region and then precipitating the dissolved portion at a second region.

FIG. 9B discloses another method to improve an antireflection property of a porous layer comprising silica-based particles by exposing the porous layer to an ambient wherein the vapor in the ambient can increase the solubility of silica, thus can facilitate dissolution of the silica-based particles. In operation 950, a layer is coated on a substrate. In operation 960, the coated layer is heat treated to form a porous layer, wherein the porous layer comprises silica-based particles. In operation 970, the porous layer is exposed to a vapor environment that is capable of redistributing the mass of the silica-based particles, for example, by transferring mass from regions of positive curvature, e.g., a protruding portion of the particles, to regions of negative curvature, e.g., a hollow portion of the particles, or the joining areas of two particles or of a particle and the substrate surface.

In some embodiments, the porous coating can be formed by a sol-gel technique. The porous coating can be formed by a partial curing process to create the porous layer, or by a fully curing process to optimize, e.g., remove moisture content, the porous layer.

In general, a sol-gel process is a process where a wet formulation (commonly called the sol or sol-formulation) is dried to form a gel coating (e.g., gel-formulation) having both liquid and solid characteristics. The gel coating is then heat treated to form a solid material. The gel coating or the solid material may be formed by applying a thermal treatment to the sol. This technique is widely used for antireflective coatings because it is easy to implement and provides films of uniform composition and thickness.

The porous coating can be a porous silicon oxide (SiO₂) coating. A sol formulation is coated on the transparent substrate. Exemplary substrates include glass, silicon, metallic coated materials, or plastics. The substrate may be a transparent substrate. The substrate could be optically flat, textured, or patterned. The substrate may be flat, curved or any other shape as necessary for the application under consideration. Exemplary glass substrates include high transmission low iron glass, borosilicate glass (BSG), soda lime glass and standard clear glass. The sol-gel composition may be coated on the substrate using, for example, dip-coating, spin coating, curtain coating, roll coating, capillary coating, or a spray coating process. Other application methods known to those skilled in the art may also be used. The substrate may be coated on a single side or on multiple sides.

The sol formulation is dried to form a gel coating. A gel is a coating that has both liquid and solid characteristics and may exhibit an organized material structure. A gel can be described as a diffuse crosslinked solid matrix, containing a dispersed liquid. The crosslinking can span any range of bonding from Van der Waals to covalent to ionic. Gels typically do not exhibit liquid characteristics, since they do not flow, a key defining feature of liquids. During the drying, the solvent of the sol-gel composition is evaporated and further bonds between the components, or precursor molecules, may be formed. The drying may be performed by exposing the coating on the substrate to the atmosphere at room temperature. The coatings (and/or the substrates) may alternatively be exposed to a heated environment at an elevated temperature above the boiling point of the solvent. The drying of the coatings may not require elevated temperatures, but may vary depending on the formulation of the sol-gel compositions used to form the coatings. In one embodiment, the drying temperature may be in the range of approximately 25 degrees Celsius to approximately 200 degrees Celsius. In one embodiment, the drying temperature may be in the range of approximately 50 degrees Celsius to approximately 60 degrees Celsius. The drying process may be performed for a time period of between about 1 minute and 10 minutes, for example, about 6 minutes. Drying temperature and time are dependent on the boiling point of the solvent used during sol formation.

The gel coating can be fully cured, e.g., heat treated to a final temperature, to form a porous coating. The annealing temperature and time may be selected based on the chemical composition of the sol-gel compositions, depending on what temperatures may be required to form cross-linking between the components throughout the coating. In one embodiment, the annealing temperature may be in the range of 500 degrees Celsius and 1,000 degrees Celsius. In one embodiment, the annealing temperature may be 600 degrees Celsius or greater. In another embodiment, the annealing temperature may be between 625 degrees Celsius and 650 degrees Celsius. The annealing process may be performed for a time period of between about 3 minutes and 1 hour, for example, about 6 minutes.

The single porous coating may have a thickness between about 5 nanometers and about 1,000 nanometers.

The following description provides a preparation of a sol formulation comprising a binder and nanoparticles. Other sol formulation preparations are similar, for example, by using a porosity forming agent.

In some embodiments, a sol formulation comprising a binder and nanoparticles can be used. In some embodiments, the binder comprises a silicon-based binder, such as a silane-based binder. The nanoparticles can comprise silicon-based nanoparticles, such as silica or siloxane-based nanoparticles. A binder can comprise a component used to bind together, e.g., by adhesion and cohesion, one or more types of materials in mixtures. The binder can comprise inorganic and organic components, for example, an alkyltrialkoxysilane-based binder or a tetraethylorthosilicate (TEOS) binder.

In one embodiment, the sol-formulation may be prepared by mixing a silane-based binder, silica based nanoparticles, an acid or base containing catalyst and a solvent system. The sol-formulation may be formed by at least one of a hydrolysis and polycondensation reaction. The sol-formulation may be stirred at room temperature or at an elevated temperature (e.g., 50-60 degrees Celsius) until the sol-formulation is substantially in equilibrium (e.g., for a period of 24 hours). The sol-formulation may then be cooled and additional solvents added to either reduce or increase the ash content if desired.

Details of sol formulations comprising a binder and nanoparticles can be found in co-owned, co-pending applications, application Ser. No. 13/195,119 with filing date of Aug. 1, 2011, entitled “Sol-gel based antireflective coatings using particle-binder approach with high durability, moisture resistance, closed pore structure and controllable pore size”; application Ser. No. 13/195,151 with filing date of Aug. 1, 2011, entitled “Antireflective silica coatings based on sol-gel technique with controllable pore size, density, and distribution by manipulation of inter-particle interactions using pre-functionalized particles and additives”, and application Ser. No. 13/273,007 with filing date of Oct. 13, 2011, entitled “Sol-gel based antireflective coatings using alkyltrialkoxysilane binders having low refractive index and high durability”, all of which are hereby incorporated by reference.

The alkyltrialkoxysilane-based binder may be represented by the general formula R₁—Si—(OR₂)₃, wherein R₁, and R₂ are the same or different and each represents an alkyl group containing 1 to 20 carbon atoms, an aryl group containing 6 to 20 carbon atoms, or an aralkyl group containing 7 to 20 carbon atoms, or a fluoro-modified alkyl group containing 1 to 20 carbon atoms. The amount of the alkyltrialkoxysilane-based binder in the sol-formulation may be present in the sol-formulation in an amount between about 0.1 wt. % and about 50 wt. % of the total weight of the sol-formulation. In some embodiments, the alkyltrialkoxysilane-based binder may be used with other binders, such as orthosilicate-based binders, for example, tetraethylorthosilicate (TEOS).

The silica based nanoparticles may be spherical or non-spherical (e.g., elongated, pearl-shaped, or disc-shaped). The silica based nanoparticles include silica based nanoparticles with at least one dimension between 10 and 200 nanometers. The silica based nanoparticles may be colloidal silica mono-dispersed in an organic solvent.

The amount of silica based nanoparticles in the sol-formulation may comprise between about 0.01 wt % to about 15 wt % of the total weight of the sol-formulation. A mass ratio of the alkyltrialkoxysilane-based binder to silica based nanoparticles may be between 60:40 and 90:10. The sol-formulation can further comprise other oxide nanoparticles, such as rare-earth-based oxide nanoparticles.

After drying to form the gel coating, a heat treatment process can be used to burn off the organic components of the binder. Exemplary inorganic materials remaining after combustion of the organic matter for a sol-formulation can include silica from the nanoparticles and silica from the binder. In general, an increase of the binder in a sol formulation would lead to a reduction in pore fraction and a corresponding increase in the refractive index of the resulting anti-reflective coating. The amount of inorganic components remaining after combustion of the organic matter in the sol formulation is called the ash content of the sol formulation.

The silica binder ash content can affect the refractive index of an anti-reflective coating. Thus sol formulations with different binder or nanoparticles characteristics can provide a coated layer with different index of refraction. For example, higher percentage of silica binder ash content can increase the silica contribution from the binders, as compared to the silica contribution from the silica particles, leading to higher index of refraction.

In some embodiments, the porous coating can be formed by a sol-gel process utilizing a sol formulation comprising a porosity forming agent. In general, a porosity forming agent comprises a chemical compound which burns off upon combustion to form a void space or pore. After drying to form the gel coating, a heat treatment process can be used to form a porous coating. For example, the porosity forming agent can decompose or combust to form voids of a desired size and shape upon heating. The porosity forming agent can lead to the formation of stable pores with variable volume and index of refraction. Further, the size and interconnectivity of the pores may be controlled via selection of the porosity forming agent, the total porosity forming agent fraction, polarity of the molecule and solvent, and other physiochemical properties of the gel phase. The porosity forming agent can comprise dendrimers, organic nanocrystals, or a molecular porogen.

In some embodiments, the porous coating can be prepared with a porosity forming agent. For example, a porosity forming agent, such as a molecular porogen is added, for example, in quantities ranging from 0.01 to 0.1 wt. % in the beginning of a hydrolysis or polycondensation reaction. At the end of such hydrolysis or polycondensation reactions, additional molecular porogen may be added, for example, in quantities ranging from about 0.1 to 5 wt. %. Initial addition of the molecular porogen results in assimilation of the molecular porogen into the polymeric network or matrix prior to aggregation (leading to significantly smaller nanopores upon annealing) and later addition of the self assembling molecular porogen results in molecular aggregation during coating leading to larger pores upon annealing. Thus multilayer coatings having smaller and larger pores, leading to higher and smaller index of refraction, respectively, could be obtained.

In some embodiments, in addition to the porosity forming agent, the sol-gel system further includes a film forming precursor which forms the primary structure of the gel and the resulting solid coating. Exemplary film forming precursors include silicon containing precursors and titanium based precursors. The sol-gel system may further include alcohol and water as the solvent system, and either an inorganic or organic acid or base as a catalyst or accelerator. A combination of the aforementioned chemicals leads to formation of sol through hydrolysis and condensation reactions. Various coating techniques, including dip-coating, spin coating, spray coating, roll coating, capillary coating, and curtain coating as examples, may be used to coat thin films of these sols onto a solid substrate (e.g., glass). During the coating process, a substantial amount of solvent evaporates leading to a sol-gel transition with formation of a wet film (e.g., a gel). Around or during the sol-gel transition, the porosity forming agent can form nanostructures. The deposited wet thin films containing micelles or porogen nanostructures may then be heat treated to remove excess solvent and annealed at an elevated temperature to create a polymerized —Si—O—Si— or —Ti—O—Ti— network and remove all excess solvent and reaction products formed by oxidation of the porosity forming agent, thus leaving behind a porous film with a low refractive index, where n is less than 1.3, to ultra low refractive index where n is less than 1.2.

In some embodiments, a sol formulation can comprise other components, for example, to form a reaction mixture by a hydrolysis or polycondensation reaction. The mixture can be designed to form multilayer coating with different porosity, resulting in multiple layers or an integrated layer having gradual changing in index of refraction.

In some embodiments, the sol-gel composition can further include an acid or base catalyst for controlling the rates of hydrolysis and condensation. The acid or base catalyst may be an inorganic or organic acid or base catalyst. Exemplary acid catalysts may be selected from the group comprising hydrochloric acid (HCl), nitric acid (HNO₃), sulfuric acid (H₂SO₄), acetic acid (CH₃COOH), and combinations thereof. Exemplary base catalysts include tetramethylammonium hydroxide (TMAH), sodium hydroxide (NaOH), potassium hydroxide (KOH), and the like.

The sol-gel composition can further include a solvent system. The solvent system may include a non-polar solvent, a polar aprotic solvent, a polar protic solvent, and combinations thereof. Selection of the solvent system and the self assembling molecular porogen may be used to influence the formation and size of micelles. Exemplary solvents include alcohols, for example, n-butanol, isopropanol, n-propanol, ethanol, methanol, and other well known alcohols. The solvent system may further include water. The amount of solvent may be from 80 to 99.9 wt. % of the total weight of the sol-gel composition.

The solvent system may further include water. Water may be present in 0.5 to 10 times the stoichiometric amount need to hydrolyze the silicon containing precursor molecules. Water may be present from 0.001 to 0.1 wt. % of the total weight of the sol-gel composition. Water may be present in 0.5 to 10 times the stoichiometric amount need to hydrolyze the silicon containing precursor molecules.

The sol-gel composition may further include a surfactant. In certain embodiments, the surfactant may be used for stabilizing the sol-gel composition. The surfactant can comprise an organic compound that lowers the surface tension of a liquid and contains both hydrophobic groups and hydrophilic groups. Thus the surfactant contains both a water insoluble component and a water soluble component. The surfactant may also be used to stabilize colloidal sols to reduce the precipitation of solids over extended periods of storage.

The sol-formulation may further include a gelling agent or solidifier. The solidifier may be used to expedite the transition of a sol to a gel. It is believed that the solidifier increases the viscosity of the sol to form a gel. The solidifier may be selected from the group comprising: gelatin, polymers, silica gel, emulsifiers, organometallic complexes, charge neutralizers, cellulose derivatives, and combinations thereof.

In some embodiments, the present invention discloses a photovoltaic device comprising a porous antireflective coating formed from the active ambient exposure as described herein. The photovoltaic device comprises a porous antireflective coating disposed on a glass substrate. The incoming or incident light from the sun can be first incident on the antireflective coating, passes there through and then through the glass substrate before reaching the photovoltaic semiconductor (active film) of the solar cell. The photovoltaic device can also include, but does not require, a reflection enhancement oxide film, and/or a back metallic or otherwise conductive contact and/or reflector. Other types of photovoltaic devices can be used, and the described photovoltaic device is merely exemplary. The antireflective coating can reduce reflections of the incident light and permits more light to reach the thin film semiconductor film of the photovoltaic device thereby permitting the device to act more efficiently.

Although the foregoing examples have been described in some detail for purposes of clarity of understanding, the invention is not limited to the details provided. There are many alternative ways of implementing the invention. The disclosed examples are illustrative and not restrictive.

What is claimed is:

1. A method of improving an antireflective coating, the method comprising
providing an antireflective coating comprising a porous layer on a transparent substrate;
exposing the porous layer to a vapor environment comprising an alkaline vapor.

2. A method as in claim 1 wherein the vapor environment further comprises water vapor.

3. A method as in claim 1 wherein the vapor environment comprises ammonia vapor.

4. A method as in claim 1 wherein the porous layer is exposed to the vapor environment at room temperature.

5. A method as in claim 1 further comprising
heat treating the porous layer during the exposure to the vapor environment at a temperature above room temperature.

6. A method as in claim 1 wherein the porous layer is not subjected to a heat treatment temperature above 300 C before exposing to the vapor environment.

7. A method as in claim 1 further comprising
removing the substrate from the vapor environment;
heat treating the substrate at a temperature above room temperature.

8. A method of forming a coated article, the method comprising
providing a transparent substrate;
forming a porous layer on the transparent substrate;
exposing the porous layer to a vapor environment comprising an alkaline vapor.

9. A method as in claim 8 wherein the vapor environment further comprises water and ammonia vapor.

10. A method as in claim 8 further comprising
heat treating the porous layer during the exposure to the vapor environment at a temperature above room temperature.

11. A method as in claim 8 wherein forming a porous layer comprises
coating the substrate with a sol-composition wherein the sol-composition comprises an alkylalkoxysilane-based binder; and
forming a gel on the substrate by drying the sol-formulation.

12. A method as in claim 8 further comprising
removing the substrate from the vapor environment;
heat treating the substrate at a temperature above room temperature.

13. A method of forming a coated article, the method comprising
providing a transparent substrate;
coating a layer on the transparent substrate;
curing the coated layer at a first temperature to form a porous layer, wherein the first temperature is above room temperature;
exposing the porous layer to a vapor environment comprising an alkaline vapor.

14. A method as in claim 13 wherein the vapor environment further comprises water and ammonia vapor.

15. A method as in claim 13 further comprising
heat treating the porous layer in the vapor environment at a second temperature, wherein the second temperature is above room temperature.

16. A method as in claim 13 wherein the second temperature is less than or equal to 300 C.

17. A method as in claim 13 wherein the porous layer is not subjected to a heat treatment temperature above 300 C before exposing the vapor environment.

18. A method as in claim 13 wherein the layer is coated by a sol-gel process.

19. A method as in claim 13 wherein coating the layer comprises
coating the substrate with a sol-composition wherein the sol-composition comprises an alkylalkoxysilane-based binder.

20. A method as in claim 13 further comprising
removing the substrate from the vapor environment;
heat treating the substrate at a third temperature, wherein the third temperature is above room temperature.
